(19) United States
(12) Patent Application Publication
(10) Pub. No.: US 2018/0027377 A1
(43) Pub. Date: Jan. 25, 2018

(54) METHOD AND SYSTEM OF PROVIDING A LOCATION SHARING EVENT FOR MEMBER MANAGEMENT

(71) Applicant: Sung-Won PARK, Seoul (KR)

(72) Inventors: Sung-Won PARK, Seoul (KR); Ho-Jin LEE, Seoul (KR)

(73) Assignee: Sung-Won PARK, Seoul (KR)

(21) Appl. No.: 15/656,357

(22) Filed: Jul. 21, 2017

(30) Foreign Application Priority Data
Jul. 25, 2016 (KR) 10-2016-0093926

(51) Int. Cl. H04W 4/02; H04W 4/10; G06Q 10/10

(52) U.S. Cl. CPC H04W 4/023; G06Q 10/1093; H04W 4/10

(57) ABSTRACT

A method of providing a location sharing event for member management comprises the steps of creating an event through a planner terminal, inputting personal information in the planner terminal, sharing an invitation link from the planner terminal to a member terminal, the member terminal participating in the event through the invitation link, displaying a real time shared screen on each of the screens of the planner terminal and the member terminal by starting the event. It is anticipated that the method and system of the present invention can be used to easily check whether the members of a group moving with a specific purpose for a predetermined period of time are moving individually, or to check each other's whereabouts in the case they are divided into smaller groups, or to check whether they are on the right track and such.

### CROSS-REFERENCE TO RELATED APPLICATIONS

This application claims the priority of Korean Patent Application No. 10-2016-0093926 filed on Jul. 25, 2016, and all the benefits accruing therefrom under 35 U.S.C. §119, the contents of which is incorporated by reference in its entirety.

### BACKGROUND OF THE INVENTION

### Field of the Invention

The present invention relates to a method and system of providing a location sharing event for member management. More particularly, the present invention relates to a method and system of sharing location information in real time between members of a group moving together with a specific purpose for a predetermined period through a simple procedure using a terminal of each member, and for providing events that are communicable by direct group communication.

### Description of the Related Art

Generally, when members of a group who move for a specific purpose travel by different cars for a predetermined period of time, they confirm where they are, whether they're on the right path and such, by phone. However, even after asking each other's whereabouts on the phone, there are limitations in explaining the location by phone and in the case where the surrounding roads are not familiar, it is hard to tell how far the members are from each other.

In addition, when a plurality of members of a group move within a plurality of vehicles or smaller groups, it is not easy for each vehicle or smaller group to keep track of where the others have reached up to and it is troublesome that several phone calls are needed to grasp each of their whereabouts. Also, if the people in a vehicle or a small group of members do not answer the call, the others cannot figure out what happened or where they are, and the leader leading the entire group will have to wait frustratingly for the members to call back.

Korean Laid-Open Patent Publication No. 2008-0081665 discloses a push to talk (PTT) mobile terminal, a PTT communication service system, and a method for displaying a location of a caller, wherein the location of a PTT mobile terminal of the caller's side is transmitted as location information each time a PTT call is made, thereby allowing the called party to check the caller's location.

With such technology, although the called party may check the caller's location while communicating with the caller, there is still a limit to how many members in a group can figure out each other's locations all at the same time. That is, according to Korean Laid-Open Patent Publication No. 2008-0081665, only the location of the caller is sent to the called party in a one-way manner, wherein location sharing in both ways cannot be performed at once. Thus it is not possible to share the locations of a leader and a plurality of members in a group with each other simultaneously in real time.

Therefore, there is a need for a technology that allows members of a moving group to easily check the location of each other simultaneously while being able to communicate with each other.

### SUMMARY OF THE INVENTION

It is an object of the present invention to provide a method and system of providing a location sharing event for member management which can be used to easily check whether the members of a group moving with a specific purpose for a predetermined period of time are moving individually, or to check each other's whereabouts in the case they are divided into smaller groups, or to check whether they are on the right track and such.

Further, it is to be understood that the present invention is not limited to the above-described subject matter, and another subject (s) not mentioned may be clearly understood by those skilled in the art from the following description.

As a solution to the problem to be solved by the present invention described above, a method of providing a location sharing event for member management, including (a) creating an event through a planner terminal; (b) inputting personal information in the planner terminal; (c) sharing an invitation link from the planner terminal to a member terminal; (d) the member terminal participating in the event through the invitation link; (e) displaying a real time shared screen on each of the screens of the planner terminal and the member terminal by starting the event; wherein location information of both the planner terminal and the member terminal are displayed simultaneously on the real time shared screen is provided.

Further, it is preferable for step (a) to include (a1) inputting a name of the event through the planner terminal; and (a2) inputting a start date and end date of the event through the planner terminal.

Further, it is preferable for step (d) to include (d1) inputting personal information of the member terminal.

Further, it preferable that in the case where there are at least two invited member terminals, before the event starts at step (e), a grouping state of the planner terminal and the member terminal is edited to set at least two leader terminals, and location information of the at least two leader terminals is displayed simultaneously on the real time shared screen.

Further, it is preferable that while the location information of the planner terminal and the member terminal displayed simultaneously on the real time shared screen, they are displayed differently based on their connection state with a server.

Further, it is preferable that (f) determining whether a PTT (push to talk) function is in an activated state; and (g) in the case where the PTT function is activated, transmitting a voice data through a communications network from any one of a planner terminal or a member terminal, and transmitting the voice data from a server to another one of the planner terminal or the member terminal, is further included.

Further, to achieve the object of the present invention, a system of providing a location sharing event for member management including, a planner terminal, at least one member terminal invited to an event created by the planner terminal, and a server communicable with the planner terminal and the member terminal through a communications network, wherein the server includes a connection management module, service management module, and voice authority management module, and a real time shared screen where location information of each of the planner terminal and the member terminal that are participating in the event through the server are displayed simultaneously is configured.

Further, it is preferable that the service management module manages a service list including at least one of a service event list, a login, map location information, a voice relay, an event information provision, and a participant information provision service.

Further, it is preferable that in the case where there are at least two invited member terminals, before the event starts, a grouping state of the planner terminal and the member terminal is edited to set at least two leader terminals, and location information of the at least two leader terminals is displayed simultaneously on the real time shared screen.

Further, it is preferable that the voice authority management module determines whether a PTT (push to talk) function is in an activated state, and in the case where the PTT function is activated, a voice data is transmitted through a communications network from any one of a planner terminal or a member terminal, and the voice data is transmitted from the server to another one of the planner terminal or the member terminal.

The details of other embodiments are included in the “Detailed Description of the Invention” and the accompanying drawings.

The advantages and/or features of the present invention and the manner of achieving them will become apparent by reference to various embodiments described in detail below with reference to the accompanying drawings.

However, the present invention is not limited to the configurations of the embodiments described below, but may be embodied in various other forms, and each embodiment disclosed in this specification is intended to be illustrative only, and it will be understood by those of ordinary skill in the art that various changes in form and details may be made therein without departing from the spirit and scope of the invention as defined by the appended claims.

According to a preferred embodiment of the present invention having the above-described configuration, events having a specific purpose for a predetermined period such as a trip, event, activity and etc., can be created to allow a planner to invite members, and the invited members can move individually to a predetermined destination of the event, or in the case they are divided into small groups, it is easy to check where each other are at, whether they are on the right path, and such.

Further, even without the members calling each other until they arrive at the predetermined destination, it is possible to keep track of whether any one member or small group is going in the wrong direction or whether they have stopped, so they can quickly communicate with each other even if an unexpected situation occurs.

In addition, it is possible to create events periodically for a certain period which allows the management of schedules and participating members of clubs or volunteer groups and the like.

Further, even if the members are located spread apart over a large area, it is possible for all of them to check where each other are, and they can easily report their state to each other using the PTT method, so the present invention may be used for work related to tasks in transportation companies, courier companies, internet/telephone installing companies, construction sites, industrial plants, and etc. It can also be used in places such as amusement parks and tourist attraction and the like for preventing children from becoming lost.

### BRIEF DESCRIPTION OF THE DRAWINGS

FIGS. 1A and 1B are flowcharts illustrating a method of providing a location sharing event for member management according to a preferred embodiment of the present invention.

FIG. 2 is a flowchart illustrating a method of a member terminal participating in an event, wherein the member terminal receives an invitation link, in a method of providing a location sharing event for member management according to a preferred embodiment of the present invention.

FIG. 3 is a configuration diagram of a system of providing a location sharing event for member management according to a preferred embodiment of the present invention.

FIG. 4 is a schematic block diagram of a server of a system of providing a location sharing event for member management according to a preferred embodiment of the present invention.

FIG. 5 is a view illustrating an initial screen of an application program to which a method and system of providing a location sharing event for member management according to a preferred embodiment of the present invention is applied.

FIGS. 6A to 6F are views illustrating the process of creating a new event through a planner terminal in an application program to which a method and system of providing a location sharing event for member management according to a preferred embodiment of the present invention is applied.

FIGS. 7A to 7D are views illustrating the process of participating in an event with a member terminal that received an invitation link from a planner terminal in an application program to which a method and system of providing a location sharing event for member management according to a preferred embodiment of the present invention is applied.

FIGS. 8A to 8C are views illustrating a function of editing event information and/or personal information in an application program to which a method and system of providing a location sharing event for member management according to preferred embodiment of the present invention is applied, on a planner terminal and/or a member terminal.

FIG. 9 is a view illustrating a function of starting or ending an event in an application program to which a method and system of providing a location sharing event for member management according to a preferred embodiment of the present invention is applied, on a planner terminal.

FIG. 10 is a view illustrating a map that is displayed upon the start of an event, and a PTT function in an application program to which a method and system of providing a location sharing event for member management according to a preferred embodiment of the present invention is applied.

FIG. 11 is a view illustrating the way an application program to which a method and system of providing a location sharing event for member management according to a preferred embodiment of the present invention is displayed on a screen in a state where another program is executed in a planner or member terminal.

FIGS. 12A to 12D are views illustrating how a method and system of providing a location sharing event for member management according to an exemplary embodiment of the present invention can be variously implemented in a case where a plurality of terminals participate in an event.

### DETAILED DESCRIPTION OF THE INVENTION

Exemplary embodiments of the present disclosure will be described in detail below with reference to the accompanying drawings.

Before describing the present invention in detail, terms and words used herein should not be construed in an ordinary or dictionary sense and should not be construed as limiting the invention to the inventors of the present invention in the best way possible, and it is to be understood that the concepts of various terms can be properly defined and used, and further, these terms and words should be construed as meaning and concept consistent with the technical idea of the present invention.

That is, the terms used herein are used only to describe preferred embodiments of the present invention, and are not intended to specifically limit the contents of the present invention, and it should be noted that this is a defined term considering that many possibilities of the present invention.

Also, in this specification, the singular forms “a”, “an”, and “the” include plural referents unless the context clearly dictates otherwise, and similarly it should be understood that even if they are expressed in plural they may include singular meaning.

Where a component is referred to as “comprising” another component throughout this specification, unless specified otherwise, this means the component does not exclude any other element but may further include any other element.

Further, when it is stated that an element is “inside or connected to another element”, this element may be directly connected to another element or may be installed in contact with it, or may be installed spaced apart with a predetermined distance, and in the case where a component is installed to be spaced apart with a predetermined distance, a third component or means for fixing or connecting the component to another component may be present, and it should be noted that the description of the third component or means may be omitted.

On the other hand, it should be understood that there is no third component or means when an element is described as being “directly coupled” or “directly connected” to another element.

Likewise, other expressions that describe the relationship between the components, such as “between” and “right between”, or “neighboring to” and “directly adjacent to” and such should be understood in the same spirit.

Further, in this specification, when terms such as “one surface”, “other surface”, “one side”, “other side”, “first”, “second” and such are used, it is to clearly distinguish one component from another, and it should be understood that the meaning of the component is not limited by such term.

It is also to be understood that terms related to positions such as “top”, “bottom”, “left”, “right” in this specification are used to indicate relative positions in the drawings for the respective components, and unless an absolute position is specified for these positions, it is not to be understood that these position-related terms refer to absolute positions.

Furthermore, in the specification of the present invention, the terms “part”, “unit”, “module”, “device” and the like mean a unit capable of handling one or more functions or operations, and may be implemented as a hardware or software, or a combination of hardware and software.

In addition, in this specification, the same reference numerals are used for the respective constituent elements of the drawings, and the same constituent elements are denoted by the same reference numerals even if they are shown in different drawings, that is, the same reference numerals indicate the same components throughout this specification.

It is to be understood that the size, position, coupling relationships and such, of each component constituting the present invention in the accompanying drawings, may be partially exaggerated or reduced or omitted to be able to sufficiently clearly convey the scope of the invention or for convenience of describing, and therefore the proportion or scale thereof may not be rigorous.

Also, in the following description of the present invention, a detailed description of a configuration that is considered to unnecessarily obscure the gist of the present invention, for example, a known technology including the prior art, may be omitted.

Hereinafter, the term “participant terminal” is defined as a concept including “planner terminal” that creates an event and a “member terminal” that is invited to the event by the planner terminal.

Hereinafter, a “group” means a unit including a plurality of participant terminals, and “leader terminal” is a terminal selected from participant terminal(s) included in one group and one leader terminal is selected for one group. Here, the leader terminal doesn't have to be the same terminal as the planner terminal.

Hereinafter, “grouping” means a task in which a plurality of participant terminals are divided into at least two groups and one leader terminal is selected for each group.

### Method of Providing a Location Sharing Event for Member Management

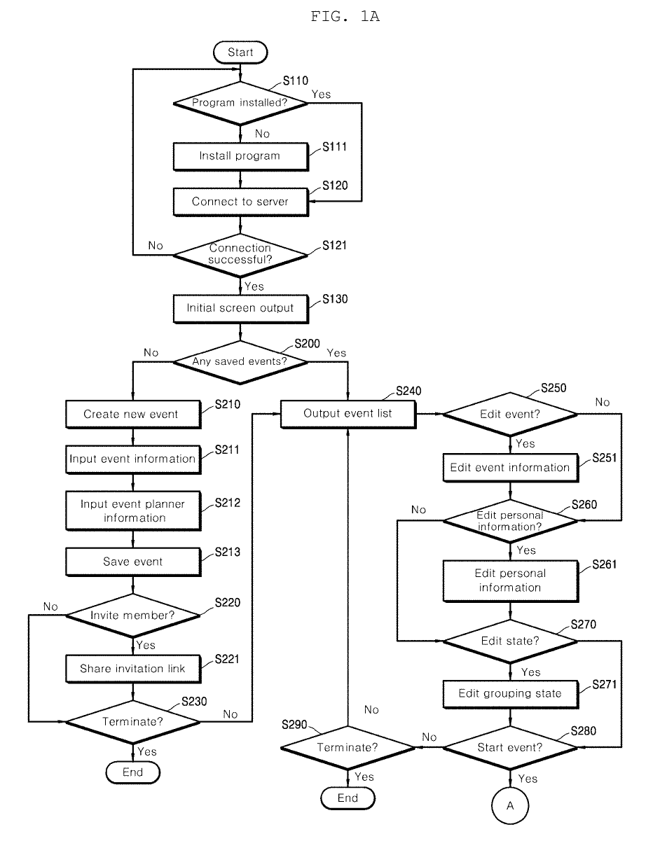

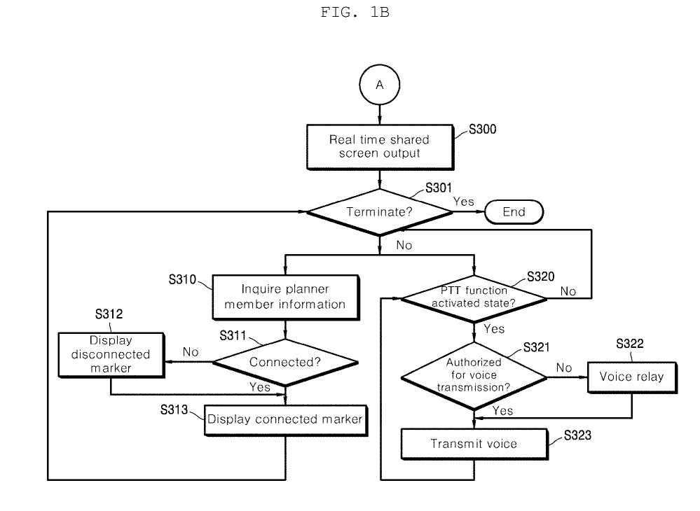

First, a method of providing a location sharing event for member management according to a preferred embodiment of the present invention will be described with reference to FIGS. 1A and 1B. FIGS. 1A and 1B are flowcharts illustrating a method of providing a location sharing event for member management according to a preferred embodiment of the present invention.

The method of providing a location sharing event for member management according to an exemplary embodiment of the present invention may include creating an event in step S210, inputting information related to the event planner terminal in step S212, sharing an invitation link with a member terminal that will be participating in the event in step S221, and outputting a shared screen in real time to a participant terminal connected to the server by starting the event in step S300.

### Method of Creating and Providing an Event

More specifically, the method of providing a location sharing event for member management according to an exemplary embodiment of the present invention may include: determining whether an application program needed for, creating an event, inputting personal information, event invitation and such, is installed on the terminal in step S110, installing the application program on a terminal in step S111 in a case where the application program is not installed, and connecting a server 200 in step S120 when the application program is installed.

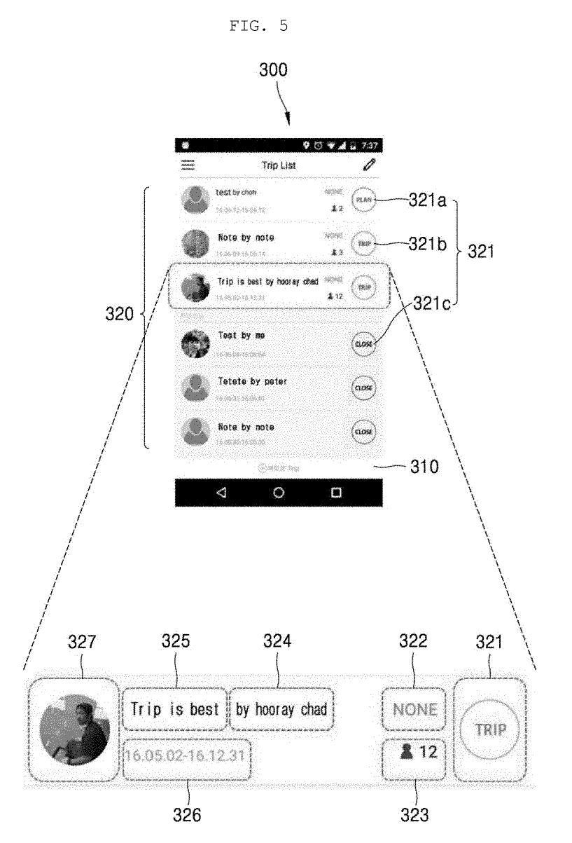

In step S121 where it is determined whether or not a terminal is successfully connected to the server 200, it is preferable that it is determined again whether or not the application program is properly installed on the terminal in step S110 if the connection is determined as unsuccessful. If the connection is successful, an initial screen 300 (see FIG. 5) is output in step S130. As the initial screen 300 is output, it is determined if there are any stored events in step S200, and if there are no stored events, a new event is created in step S210. If there is a stored event, an event list is output in step S240.

The case where there are no stored events is described in more detail. When a new event is created in step S210, information on the event, for example, information such as an event name, a picture, and a period is input in step S211.

When the information on the event is input, information such as a user name and a picture of the user of the planner terminal, which is the terminal that created the event, is input in step S212.

When the information about the event and the user of the planner terminal is input and stored in step S213, it is determined whether or not to invite a member to participate in the event in step S220. If there is a member to invite, an invitation link is shared with a member terminal in step S221. If there is no member to be invited, it is preferable to determine whether to terminate the application program in step S230 or to output the event list in step S240.

### Method of Editing and Executing an Event

According to the present invention, after the application program is installed, the user can directly access the server without separately registering an ID and a password. As a result, anyone who simply installs the application program can create an event, enter a name and photo that other users can see, and send an invitation link to another terminal.

When an event is newly created or an existing event is stored, an event list is output in step S240. It is preferable that event items displayed on the output event list are configured so they may be edited or deleted, and the user of the planner terminal can determine whether or not to edit the event information in step S250. In the event information editing step in step S251, the user of the planner terminal can edit information such as the name, photo or period of the event. It is preferable that only the planner terminal that first created the event is authorized to edit the event information.

The user of a planner terminal and a user of a member terminal invited to an event by the planner terminal can determine whether or not to edit their respective personal information in step S260, apart from the editing of event information. Personal information may be edited in step S261 using the planner terminal or member terminal, that is, a participant terminal.

In step S270, it is possible to determine whether or not to edit the grouping state with a participant terminal, apart from the editing of personal information. The grouping state may be edited by each of the participant terminals in step S271 in such a way where the more participant terminals there are, the more diverse the groupings in which participant terminals may be arranged.

Grouping is the task of dividing a plurality of participant terminals into at least two groups and selecting one leader terminal for each group. In step S271 where the grouping state is edited, the participant terminal(s) to be placed in each group and a leader terminal selected from the participant terminal(s) may be set. The planner terminal is preferably selected as a leader terminal of one group, but another member terminal may be selected and set as the leader terminal of the group.

After all sorts of editing work is done in the event information editing step of step S251, personal information editing step of S261, and grouping state editing step of S271, it is determined whether or not to start an event in step S280, or the application program may be terminated in step S290.

The case where an event is started will be described in further detail with reference to FIG. 1B. Simultaneously with the start of the event, a shared screen is output in real time in step S300. Here, the shared screen is a screen where the location information of each participant terminal is displayed on the participant terminal connected to the server and shared with each other.

The application program can be terminated in step S301 from when the shared screen is output in real time in step S300. However, if the application program is not terminated, the steps of: inquiring information of a plurality of participant terminals including planner and member terminals in step S310, determining whether or not each of the participant terminals are connected in step S311, displaying a disconnected participant terminal on the shared screen with a disconnected marker in step S312, and displaying a connected participant terminal on the shared screen with a connected marker in step S313, are executed and the locations of the disconnected marker and connected marker of the participant terminals are periodically updated and displayed on the shared screen.

At the same time, it is confirmed which of the participant terminals intends to use the push to talk (PTT) function through step S320 of determining whether or not the PTT function is activated, and in step S321, it is determined whether the participant terminal that intends to use the PTT function has voice transmission authority or not. If it is determined that the participant terminal does not have voice transmission authority, the voice transmission step S323 may be smoothly performed through the voice relay step S322.

While the shared screen is displayed, the location information of each participant terminal is shared and displayed as described above, and the PTT function can be used. The application program may be immediately terminated, but the providing method of the present invention may be configured so that the event list is output again from the shared screen.

### Method of Participating in an Event

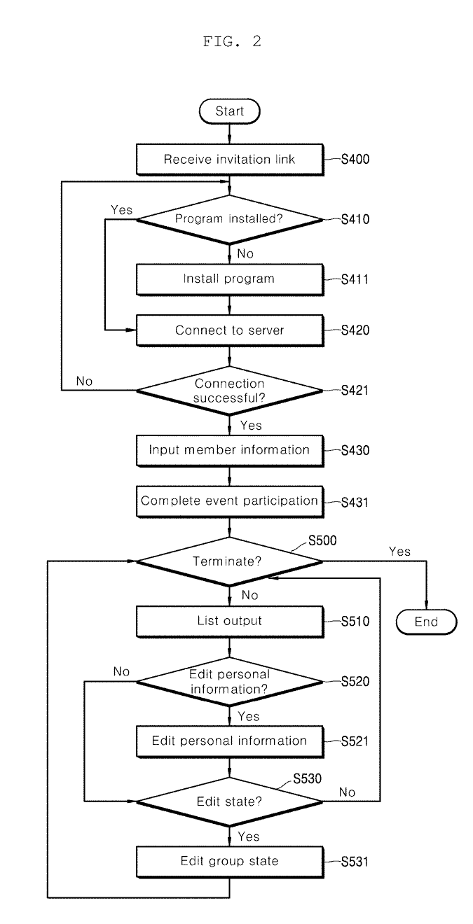

Referring to FIG. 2, a method of participating in an event without a particular registration procedure wherein the member terminal side receives an invitation link from the planner terminal will be described. FIG. 2 is a flowchart illustrating a method of a member terminal participating in an event, wherein the member terminal receives an invitation link, in a method of providing a location sharing event for member management according to a preferred embodiment of the present invention.

The method for providing a location sharing event for member management according to an exemplary embodiment of the present invention includes receiving an invitation link in step S400, determining whether the application program need for not only creating an event, inputting personal information, inviting to an event, but also participating in an event is installed on a terminal in step S410. If the application program is not installed, the application program is installed on the terminal in step S411. If the application program is installed, the method further includes the terminal connecting to a server 200 in step S420.

It is determined whether or not the terminal is successful in connecting to the server 200 in step S421. In the case where it is determined in step S421 that the connection is unsuccessful, it is preferable that it is determined again whether or not the application program is properly installed on the terminal in step S410. If the connection is successful, inputting information such as a name and a picture of a user of a member terminal in step S430 may be performed to easily complete the participation of the event in step S431.

When the information of the user of the member terminal is inputted and stored, it is preferable that after determining whether or not to terminate the application program in step S500, the application program is terminated or an event list is output in step S510.

The user of the member terminal can determine whether or not to edit their personal information in step S520, and can edit the personal information with the member terminal in step S521. In step S530, it is possible to determine whether or not to edit the grouping state with a participant terminal, apart from the editing of personal information. The grouping state may be edited by each of the participant terminals in step S531 in such a way where the more participant terminals there are, the more diverse the groupings in which participant terminals may be arranged.

Upon completion of the editing of personal information and/or grouping state through the member terminal are done, it is determined whether or not to terminate the application program in step S500 and the application program may be terminated. It is preferable for the authority to start an event to be given to the planner terminal that created the event, but in another embodiment, after the editing work is done, the authority to decide whether to start an event may also be given to a member terminal.

### Location Sharing Event Providing System for Member Management

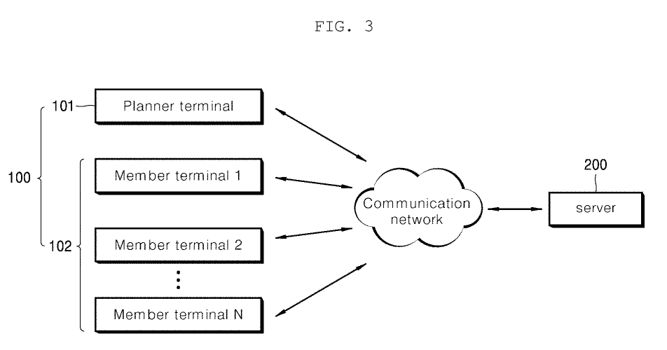

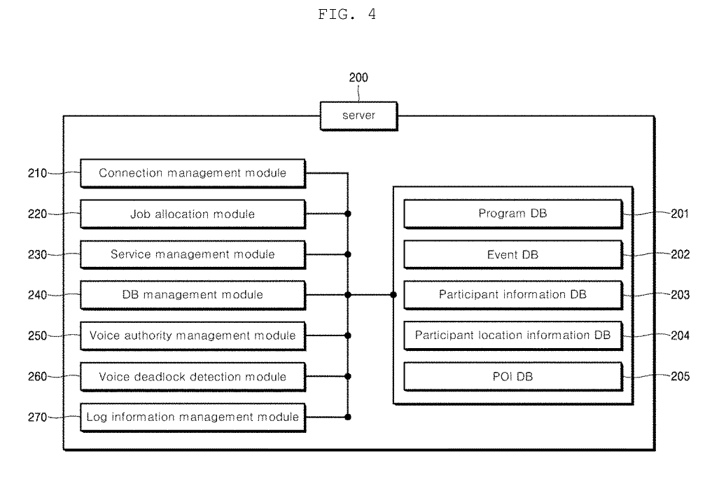

Next, referring to FIGS. 3 and 4, a location sharing event providing system for member management according to an exemplary embodiment of the present invention will be described.

FIG. 3 is a configuration diagram of a system of providing a location sharing event for member management according to a preferred embodiment of the present invention. FIG. 4 is a schematic block diagram of a server 200 of a system of providing a location sharing event for member management according to a preferred embodiment of the present invention.

### System Configuration

The location sharing event providing system for member management according to the preferred embodiment of the present invention includes a planner terminal 101 and a plurality of participant terminals 100 including at least one member terminal 102, and a server 200 for transmitting and receiving data to and from the plurality of participant terminals 100 through a communication network such as the internet.

Here, both the planner terminal 101 and the member terminal 102 are terminals, and the side that sends an invitation link should be understood as the planner terminal 101 and the side receiving the invitation link should be understood as the member terminal 102. A terminal is preferably a device that is portable, such as a smart phone, and is capable of communicating with a server, but is not limited thereto.

### Server Configuration

The server 200 will be described in more detail with reference to FIG. 4. As shown in FIG. 4, the server 200 includes a connection management module 210 for managing a communication network user, a job allocation module 220 for allocating a job thread to process a job request received through the communication network, a service management module 230 that can efficiently provide a service requested through a communication network, a DB (database) management module 240 that manages and provides resources for efficiently using database resources in a service, a voice authority management module 250 for managing the authority of transmitting and receiving voice data, a deadlock detection module 260 for monitoring a deadlock of a voice stream transmission thread, and a log information management module 270 for managing log information to be output throughout the server 200.

The connection management module 210 is preferably configured to be able to operate a waiting socket pool for high performance connection management. By operating the standby socket pool, it is possible to solve performance and resource problems according to the capacity of the server 200 consumed each time the socket resource is generated.

In particular, the connection management module 210 initially has a certain amount of standby sockets. When a connection occurs, the connection management module 210 can allocate standby sockets to activate the connection. When the connection is broken, the active sockets can be deactivated and be returned back to standby sockets. The connection management module 210 can create and allocate a new socket when a standby socket is exhausted. If the standby sockets grow to a great amount, the connection management module 210 releases a certain amount of socket resources to secure the resources of the server 200 as much as possible. Accordingly, it is possible to provide a quick connection service to users of a plurality of participant terminals 100 connecting to the server 200.

Preferably, the job allocation module 220 is configured to operate the thread pool in order to manage resources of the server 200 as efficiently as possible. Preferably, the individual threads are configured to have their own respective state information, and a life cycle is managed based on the state information. The job allocation module 220 can wait for a predetermined time when there is no job to be assigned, and can make a notification of being inoperable when there is no job to be assigned after a predetermined time. Accordingly, it is possible to provide a quick response to a job request to users of a plurality of participant terminals 100 connected to the server 200.

Preferably, the service management module 230 is configured to provide service through information configuring a service list. The service list may be, for example, a list of services including a list of events, a login, map location information, a voice relay, and a service of providing information of an event or a participant.

The service that can be provided by the service management module 230 will be described in more detail. The service management module 230 provides information. about the status of an event, such as whether the event is in a planning phase, a progress phase, or an ending phase. In addition, the service management module 230 can provide a service for determining whether or not the participant terminal 100 is connected to the server 200.

The map location information providing service of the service management module 230 is a service wherein location information of a participant terminal 100 is collected by using a global positioning system (GPS), a communication network, and the internet, and such location information is transmitted periodically to the server 200 and can be shared between participant terminals.

Here, the map location information may be managed in the form of coordinate data, and the service providing the map location information of the service management module 230 preferably includes a service for managing the coordinate data.

The voice relay service is a service that enables voice to be transmitted to other participant terminals 100 even when a plurality of participant terminals 100 desire to simultaneously use the PTT function, only through the participant terminal 100 having voice transmission authority.

The information providing service of an event or participant is a service that provides information such as a name and picture of an event, and a name and picture of a participant, so that an event list can be output at the same time as when a terminal identified as a participant terminal 100 participating in an event accesses the server 200.

A service request is first transferred to the service management module 230 after a job thread is allocated by the job allocation module 220. The service management module 230 may promptly provide the service to a user of a participant terminal 100 through analyzing a protocol, extracting the requested service, and activating the service.

The service management module 230 is a module that cancels the service if the protocol is unsuitable in the step of analyzing the protocol, calls the requested service if the protocol is suitable, and manages the errors or troubles and such that occur in individual service providing processes.

Preferably, the DB management module 240 may be configured to improve the process time by operating a connection pool to allow the service management module 230 providing the services as described above, to efficiently use database resources. The DB management module 240 provides standardized functions to allow access to various DBMS (database management system) resources such as Oracle and MySQL ((my structured query language) with the same operation. Also, it is preferable that the DB management module 240 manages a data set so as to service large-capacity data.

Preferably, the voice transmission authority management module 250 may be configured so that voice can be transmitted after confirming whether a user has a voice transmission authority in the case where a user of a participant terminal 100 wants to transmit voice using the PTT function. The voice transmission authority is requested to the server 200 when the PTT function of the participant terminal 100 is activated, for example, when the PTT button displayed on the screen of the participant terminal 100 is pressed.

The server 200 checks the grouping state of a plurality of participant terminals 100 to determine if there is any participant terminal 100 with voice transmission authority and then if there is no participant terminal 100 with voice transmission authority at the requested time, the server 200 gives the voice transmission authority to the requesting participant terminal 100.

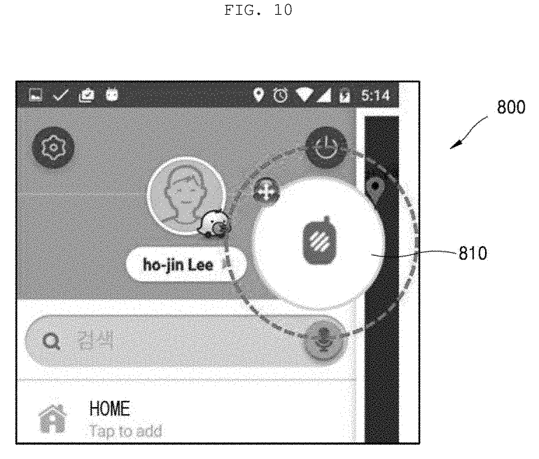

If the voice transmission authority is not permitted, the voice transmission authority management module 250 may notify the requesting participant terminal 100 with a message, a type of notification alarm, or in another way. In the case there is a participant terminal 100 that has been given voice transmission authority, it is preferable that at least a part of a voice transmission/reception icon 721 (see FIG. 10), which is a PTT function button, is displayed to change into a different color on the screen of another participant terminal 100 so that the user of the participant terminal 100 is notified of the state of the PTT function being used.

Preferably, the voice deadlock detection module 260 is configured to monitor deadlocks of a thread in an active voce stream service. Voice deadlock may occur when a plurality of participant terminals 100 are grouped into a plurality of groups and the voice transmission authorization is repeated or the communication network terminates abnormally.

In the case where a certain participant terminal 100 has voice transmission authority when there is no actual voice transmission, the voice deadlock detection module 260 retrieves the voice transmission authority so that a plurality of groups can stably utilize the PTT function.

Preferably, the log information management module 270 operates as a thread so as not to affect the operation of the server 200 and is configured to have as much effective time as possible in accordance with the amount of data. The log information may consist of a file, a log DB (not shown), a file, and a DB. The log information management module 270 is preferably configured to have a certain format for interlocking with the log analyzer. The log information management module 270 can manage the valid status information of the server 200 with a separate key, and can notify important information such as errors, warnings and the like through an alarm function.

Preferably, the server 200 may further include a program DB 201, an event DB 202, a participant information DB 203, a participant location information DB 204, and a POI (point of interest) database 205, selectively as needed.

Preferably, the program DB 201 is a database storing data for configuring an application program to which a system and method of providing location sharing events for member management according to the preferred embodiment of the present invention is applied.

The event DB 202, the participant information DB 203, and the participant location information DB 204 are preferably provided in the server 200 particularly when the user of a participant terminal 100 desires to save and store event related information in a method and system of providing a location sharing event for member management according to a preferred embodiment of the present invention. It is preferable that the user of the participant terminal 100 who wants to use the event DB 202, the participant information DB 203, the participant location information DB 204 and the POI DB 205 creates an ID using an e-mail address and a password through a registration procedure.

According to the present invention, since a UUID (universally unique identifier) is generated for each participant terminal 100, each participant terminal 100 can be automatically recognized and identified without a separate registration procedure. If the registration procedure for creating an ID is performed, event records and personal information may be maintained even when a user of a participant terminal 100 replaces a terminal or formats an operating system (OS).

When an ID is generated through a registration procedure in addition to the UUID, the records of events created or participated with each ID can be stored in the event DB 202. The event DB 202 preferably has a function of storing related records even after an event such as a trip, a project, and the like is created, started, and terminated.

In addition, it is preferable that the information of a user corresponding to each ID is stored in the participant information DB 203. Accordingly, even when an OS is formatted or a terminal is replaced, ID information can be used to identify participant information such as an existing name and a photograph.

The location information of a user corresponding to each ID is preferably stored in the participant location information DB 204. The participant location information DB 204 may be configured to store location records of a plurality of participant terminals 100 for each event so as to inquire a movement route of all the participant terminals 100 participating in each event.

Preferably, the POI DB 205 is a database for storing location information of any specific place input from the participant terminal 100, for example, a database for storing coordinates on a map. The location information of the specific place that is input with the participant terminal 100 and stored in the POI DB 205 may be displayed on the real time shared screen 700 as an element such as a star icon.

Further, the POI-related data stored in the POI DB 205 may include not only location information but also additional information about a specific place such as the category of a business being for example, a convenience store, a restaurant, a gas station, and so on, as well as customer satisfaction ratings and comments. Accordingly, the location and information of the POI input from one participant terminal 100 on the real time shared screen 700 can be shared with another participant terminal 100.

A method and system of providing a location sharing event for member management according to a preferred embodiment of the present invention may be configured so as to only allow a planner terminal 101 to edit event information such as the event name and picture, but in another embodiment, a method and system may be configured to further include a step and configuration of inputting information on a POI to be displayed on the real time shared screen 700 of an event, so that a member terminal 102 may also input and/or edit the PCI information.

The method and system of providing a location sharing event for member management according to a preferred embodiment of the present invention may be configured such that information on a specific place can be instantly added to the real time shared screen 700 by a participant terminal 100 even during an event, so that the information may be shared with all of the participant terminals 100.

### Application

Referring to FIGS. 5 to 11, an application program to which a method and system of providing a location sharing event for member management according to a preferred embodiment of the present invention is applied will be described.

FIG. 5 is a view illustrating an initial screen 300 of an application program to which a method and system of providing a location sharing event for member management according to a preferred embodiment of the present invention is applied.

The initial screen 300 includes a new event creating button 310 and an event list 320. If there are no existing saved events, it is a new event may be created using the new event creating button 310. Existing saved events may be displayed in a list form on the event list 320.

The event list 320 may be configured to display an event status icon 321, 321a, 321b, 321c, the number of group leaders 322, the number of participating members 323, planner name 324, event name 325, event period 326, and event picture 327 for each event.

The event status icons 321a, 321b, 321c are displayed on the display screen of the display unit 322. The display unit 322 displays the number of participating members 323, the name of the planner 324,

Preferably, the event status icons 321a, 321b, and 321c are displayed differently depending on which phase the event is in, for example, a planning phase (plan), a progress phase (trip), or an end phase (close).

The number of group leaders 322 is preferably displayed in accordance with which of the participant terminals 100 is set as the leader terminal in the step S271 of editing the grouping state. Since one leader terminal per group is set, it is possible to know how many groups the entire participant terminals 100 are divided through the number displayed as the number of group leaders 322. Here, if the group is not set through editing the grouping state in step S271 yet, it is preferably displayed as ‘NONE’. Also, it is preferable that users of the participant terminals 100 are connected to a screen for editing the grouping state by pressing the portion where the number of group leaders 322 is displayed.

Preferably, the number of participating members 323 preferably represents the total number of participant terminals 100 including a planner terminal 101 and member terminals 102. Preferably, information such as the names and pictures input with all the participant terminals 100 are displayed on the screens of the participant terminals 100 by pressing or touching the number of participating members 323 on the screen.

The planner name 324 is a part for displaying the name of the user of the planner terminal 101 that created the event. Preferably, by being selected by a member terminal 102, the profile of the user of the planner terminal 101 including the name and the picture of the user is displayed on the screen of the member terminal 102. When the planner name 324 is selected on the planner terminal 101, it is preferable that they are connected to a screen where the personal information of the planner terminal 101 can be edited.

The event period 326 is a part indicating the start date and/or time of an event and the ending date and/or time of the event, and is preferably displayed by being selected by a participant terminal 100, through a schedule chart or a calendar indicating the schedule. At this time, the event period 326 part may be configured so it is connected to a screen on which text may be input in a schedule chart or calendar with a participant terminal 100.

The event name 325 and the event picture 327 are parts for displaying the name and the picture of an event, respectively. By having the event name 325 be selected on a participant terminal 100, it can be connected to a screen such as a map including the POI registered in the event. Also, the event picture 327 may be selected to be connected to the enlarged image screen of the picture.

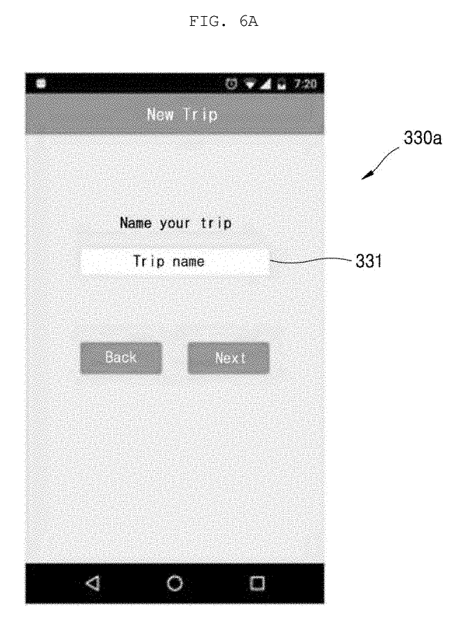

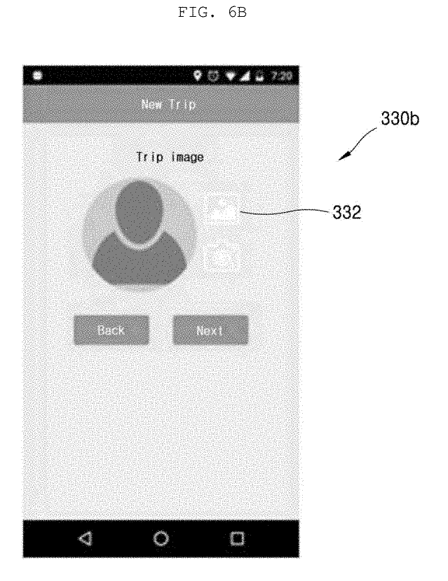

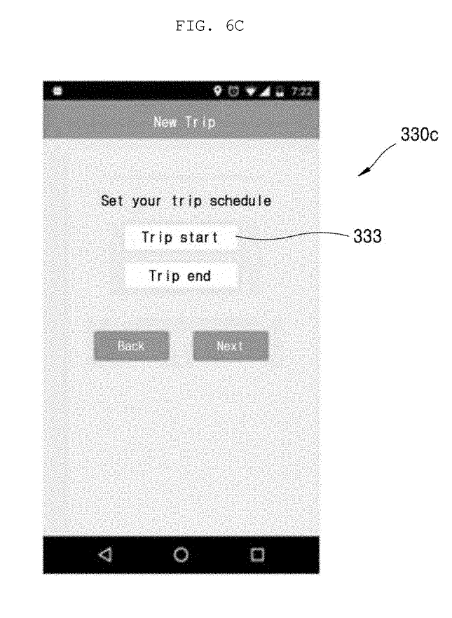

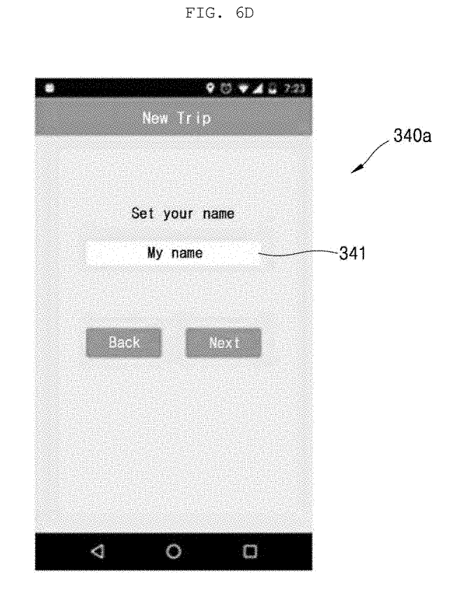

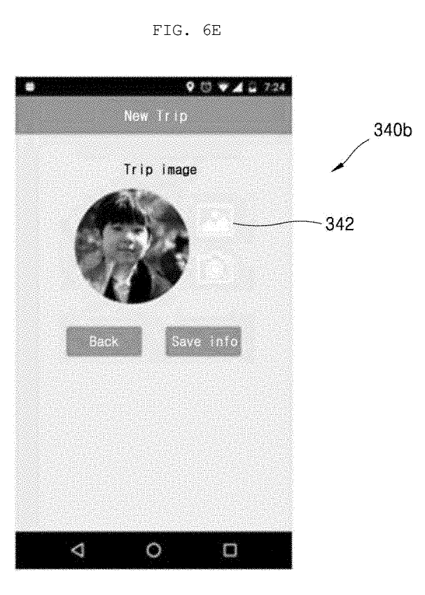

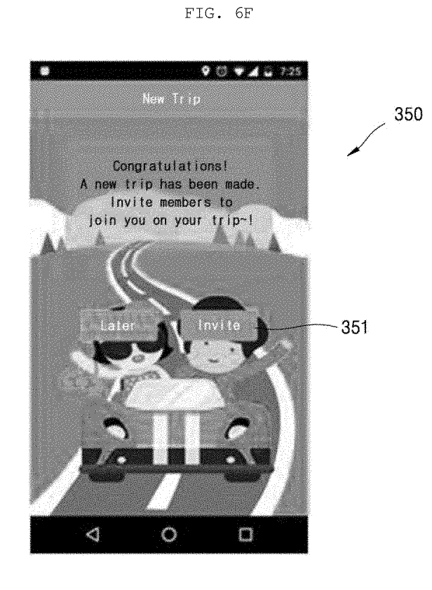

The process of creating a new event will be described with reference to FIGS. 6A to 6F. FIGS. 6A to 6F are views illustrating the process of creating a new event through a planner terminal in an application program to which a method and system of providing a location sharing event for member management according to a preferred embodiment of the present invention is applied.

When a new event creation button 310 is selected in the initial screen 300, it is preferable that the event creation screens 330a, 300b, and 300c as shown in FIGS. 6A to 6C are displayed step by step. The name of the event can be input into the event name input field 331, a picture can be input by selecting an event picture setting icon 332, and by selecting an event period setting icon 333 the start and end date of the event can be set by the planner terminal 101 on respective event creation screens 330a, 300b and 300c.

After the name, picture, and period information of the event are input, the name to be displayed for a planner terminal 102 may be input in the planner name input field 341 through the planner information input screens 340a and 340b as shown in FIGS. 6D and 6E, respectively, and a picture for representing the planner terminal 102 can be set by selecting the planner photo setting icon 342.

When the event information and the planner information are input, it is preferable that an event invitation screen 350 including an event invitation icon 351 is displayed so that an invitation link can be shared with a member terminal 102 as shown in FIG. 6F.

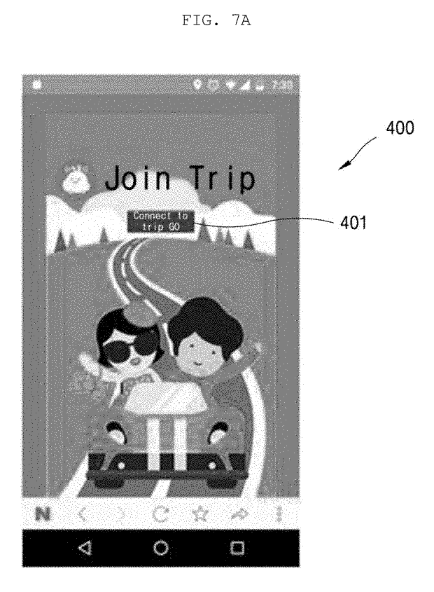

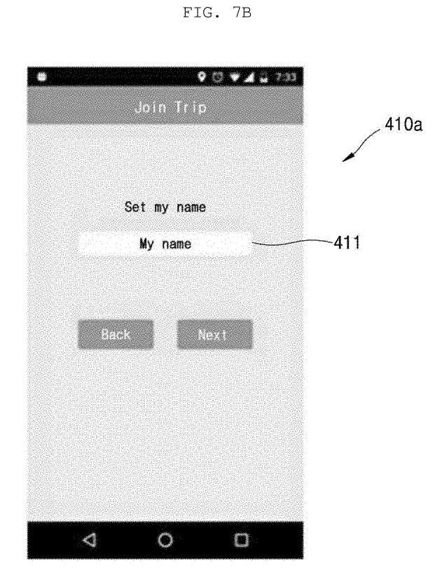

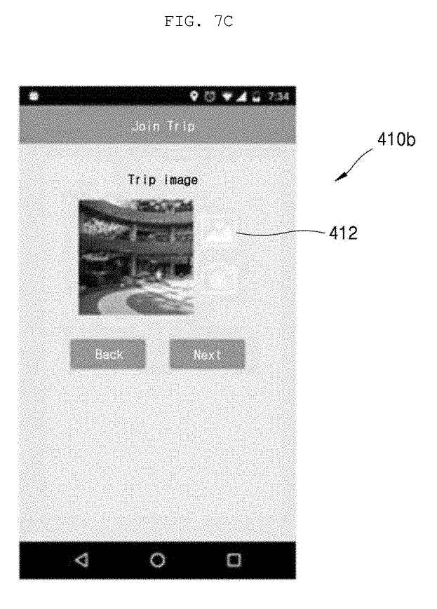

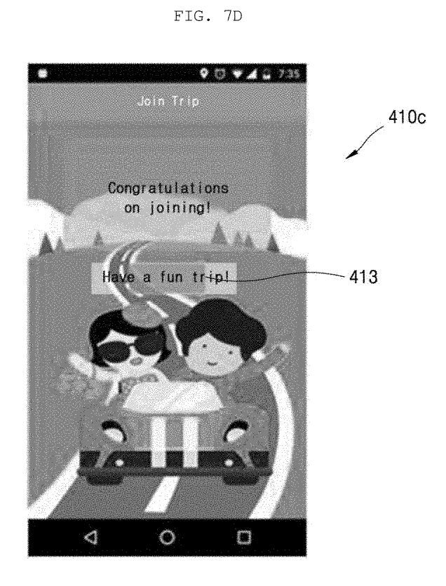

Referring to FIGS. 7A to 7D, a process of joining an event with a member terminal 102 that received an invitation link will be described. FIGS. 7A to 7D are views illustrating the process of participating in an event with a member terminal that received an invitation link from a planner terminal in an application program to which a method and system of providing a location sharing event for member management according to a preferred embodiment of the present invention is applied.

When the application program is not installed on the member terminal 102 that received the invitation link, it is preferable that the member terminal 102 is directed to an application program installation screen (not shown) so that the application program is installed first. When the application program is normally installed, it is preferable that the event participation screen 400 including an event participation icon 401 is displayed on the screen of the member terminal 102 as shown in FIG. 7A.

Preferably, the member information input screens 410a, 410b, and 410c are displayed step by step by selecting the event participation icon 401. The member terminal 102 may participate in an event through a member name input field 411, a member picture setting icon 412, and a member participation complete icon 413 of the respective member information input screens 410a, 410b and 410c, where the name and picture to represent the member terminal 102 is set.

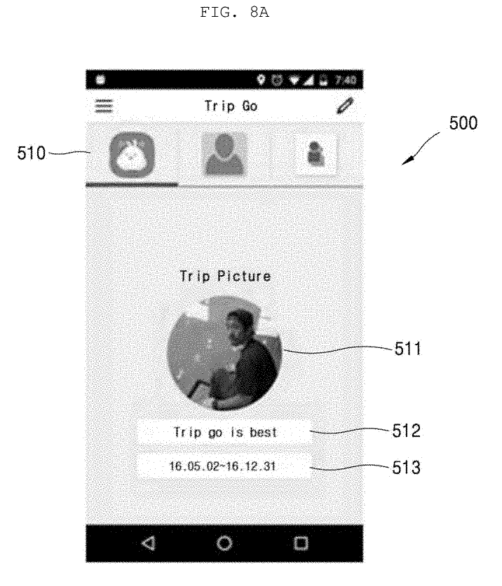

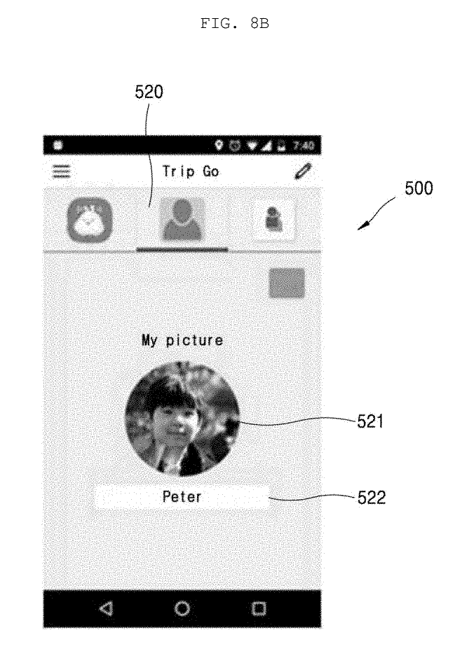

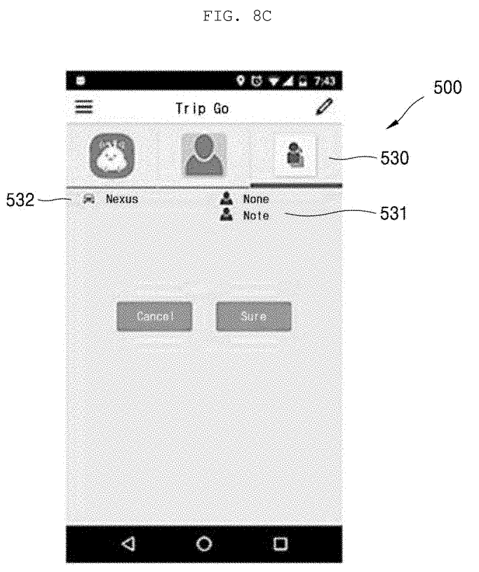

Referring to FIGS. 8A to 8C, a function of editing event information and/or personal information on a planner terminal 101 and/or a member terminal 102 will be described. FIGS. 8A to 8C are views illustrating the function of editing event information and/or personal information in an application program to which a method and system of providing a location sharing event for member management according to a preferred embodiment of the present invention is applied, on a planner terminal and/or a member terminal.

Preferably, an information editing screen 500 includes an event information edit tab 510, a participant picture edit tab 520 and a participant grouping edit tab 530 as shown in FIGS. 8A to 8C.

A planner terminal 101 may reset the picture, name and/or period of an event through an event picture editing portion 511, an event name editing portion 512 and an event period editing portion 513, respectively, in the event information edit tab 510.

A planner terminal 101 and a member terminal 102 can reset the picture and name representing each terminal through a participant picture editing portion 521 and a participant name editing portion 522, respectively, in the participant picture edit tab 520.

A planner terminal 101 and a member terminal 102 can edit the grouping state by moving a picture or name representing each of them in the participant grouping edit tab 530 to either one of a member placement portion 531 or a leader placement portion 532. Here, a participant terminal 100 moved to the leader placement portion 532, is identified as a leader terminal, and one leader terminal is recognized as one group. However, there can be cases where a group may be consisted of only one leader terminal and there can also be cases where a group may be consisted of a leader terminal as well as participant terminals. That is, the number of terminals included in one group may be one or more.

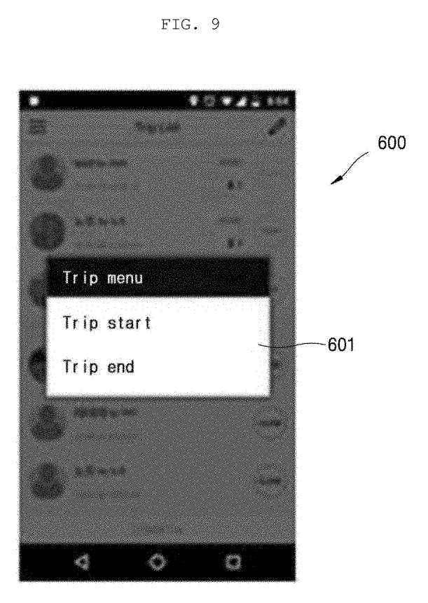

The method of changing the status of an event from plan, trip (progress), to an end phase will be described with further reference to FIG. 9. FIG. 9 is a view illustrating a function of starting or ending an event in an application program to which a method and system of providing a location sharing event for member management according to a preferred embodiment of the present invention is applied, on a planner terminal.

An event menu tab 601 included in an event menu screen 600 may be displayed on the participant terminal 100 as shown in FIG. 9 by selecting an event status icon 321 on an initial screen 300 on which an event list is displayed, but method of approach is not limited to this.

The manner in which events are shared with each participant terminal 100 will be described with reference to FIG. 10. FIG. 10 is a view illustrating a map that is displayed upon the start of an event, and a PTT function in an application program to which a method and system of providing a location sharing event for member management according to a preferred embodiment of the present invention is applied.

A real time shared screen 700 is preferably a map in which GPS location information of a plurality of participant terminals 100 participating in an event is simultaneously displayed. As the real time shared screen 700 is activated, the GPS location information of each of the plurality of participant terminals 100 is transmitted to the server 200 and is displayed on the real time shared screen 700 while being updated according to a predetermined period.

Preferably, the real time shared screen 700 includes a map tool icon 710, a PTT function portion 720, a connected marker 731, a disconnected marker 732, a voice transmitter record display portion 740, and a final login record display portion 750.

Preferably, the map tool icon 710 includes a map center setting icon 711, a participant display setting icon 712, a map zoom-in icon 713, and a map zoom-out icon 714. By selecting the map center setting icon 711 the location of the participant terminal 100 may be set to be positioned at the center of the map displayed on the participant terminal 100.

By selecting the participant display setting icon 712, all of the participant terminals 100 can be displayed on the real time shared screen 700. When there is at least one participant terminal 100 (disconnected terminal) that is not connected to the server among the participant terminals 100, it is preferable that by selecting the participant display setting icon 712, only the participant terminals 100 that are connected to the server (connected terminal) are displayed on the real time shared screen 700.

Accordingly, only the participant terminal 100 in the connected state can be displayed on the real time shared screen 700 by selecting the participant display setting icon 712, thereby allowing the users to know the locations of the connected participant terminals 100 more easily.

The map zoom-in icon 713 and the map zoom-out icon 714 are preferably tools having a function of enlarging and reducing the screen scale in a typical map application program.

The PTT function portion 720 preferably includes a voice transmission/reception icon 721 and an elapsed time display unit 722. The voice transmission/reception icon 721 is preferably displayed in different colors at the time of voice transmission, at the time of voice reception, or at the time of voice transmission/reception standby. For example, when a voice transmission/reception icon 721 is selected in one participant terminal 100 and a voice is transmitted to another participant terminal 100, it is preferable that the voice transmission/reception icon 721 turns blue, and at a voice transmission/reception standby state, yellow, and when receiving voice, red. In addition, when the voice transmission/reception icon 721 is not selected and is in the standby state, it is preferable that the icon is gray.

The connected marker 731 and the disconnected marker 732 are preferably displayed differently in order to distinguish the state when the participant terminal 100 is connected to the server and the state where the participant terminal 100 is not connected, respectively. When the participant terminal 100 that has not been connected is connected to the server 200 at a later time, according to a predetermined period, it is determined whether or not the connection is established and the marker representing the participant terminal 100 is updated from the disconnected marker form to the connected marker form, and the location information is also updated to be displayed on the map of the real time shared screen 700.

When the participant terminal 100 is disconnected from the server 200, the participant terminal 100 is preferably displayed on the map of the real time shared screen 700 according to the location information that was recorded last. At this time, the connected marker 731 and the disconnected marker 732 displayed on the real time shared screen 700 are preferably the participant terminal 100 set as a leader terminal. By selecting the respective markers 731 or leader terminals, the information of other participant terminals 100 in the group to which each leader terminal belongs can be displayed as a list.

The voice transmitter record display portion 740 displays the name and the transmitted time of the participant terminal 100 that has most recently transmitted voice through the PTT function. The final login history display portion 750 is a portion that indicates the time when the participant terminal 100 that is not connected to the server 200 of the participant terminal 100 last accessed the server 200. It is desirable to indicate the elapsed time since the last connection time.

Also, by selecting the final login record display portion 750, the map of the real time shared screen 700 can be zoomed-in or zoomed-out while having the connected marker 731 at its center. In another embodiment, another icon other than the final login record display portion 750 may be selected to output a screen having a connection marker 731 at its center, and the present invention is not limited thereto. Accordingly, the user of the participant terminal 100 can easily know the distribution of the connected marker 731 by pressing the final login record display portion 750 or another icon on the screen.

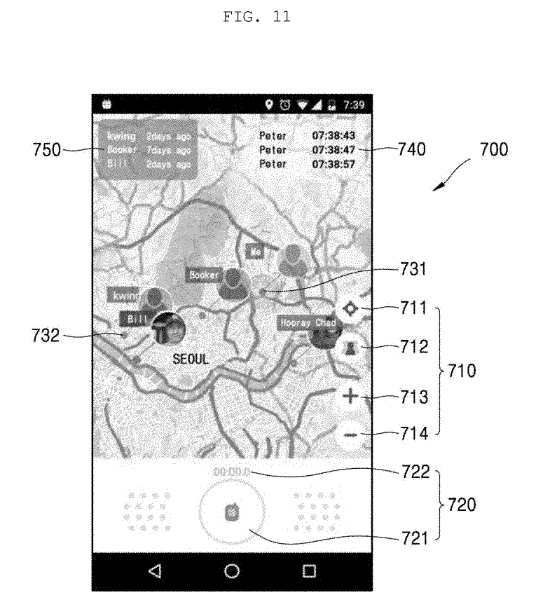

Other functions of the application program will be described with further reference to FIG. 11 is a view illustrating the way an application program to which a method and system of providing a location sharing event for member management according to a preferred embodiment of the present invention is displayed on a screen in a state where another program is executed in a planner or member terminal.

As shown in FIG. 11, an application program according to an exemplary embodiment of the present invention may be configured such that a PTT push icon 811 is displayed on another program screen 800 so that the PTT function can be performed while another program is being executed. The PTT push icon 811 preferably includes a function that can be freely moved on the screen of the participant terminal 100 and provide a connection to the real time shared screen 700 again.

### Embodiment of Grouping

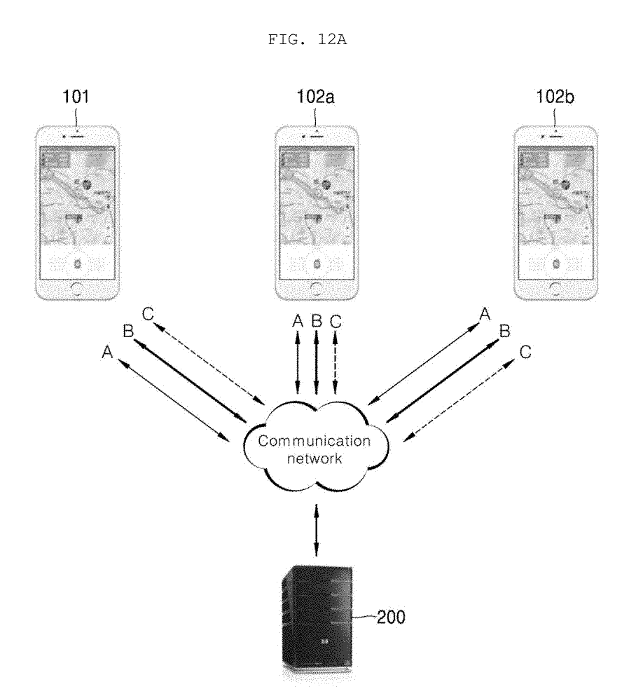

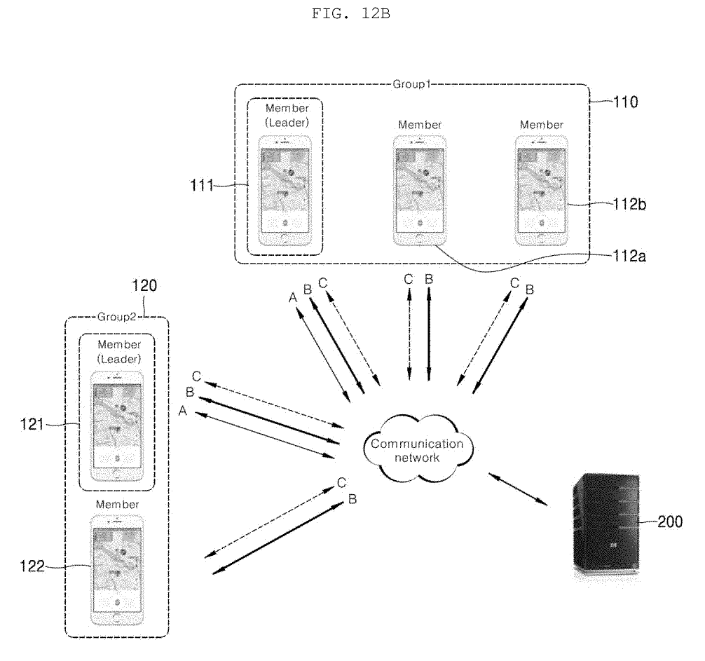

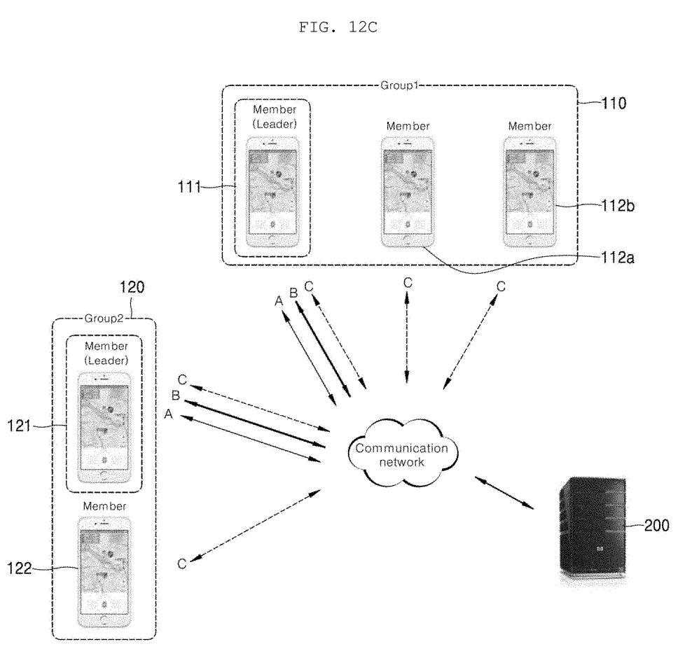

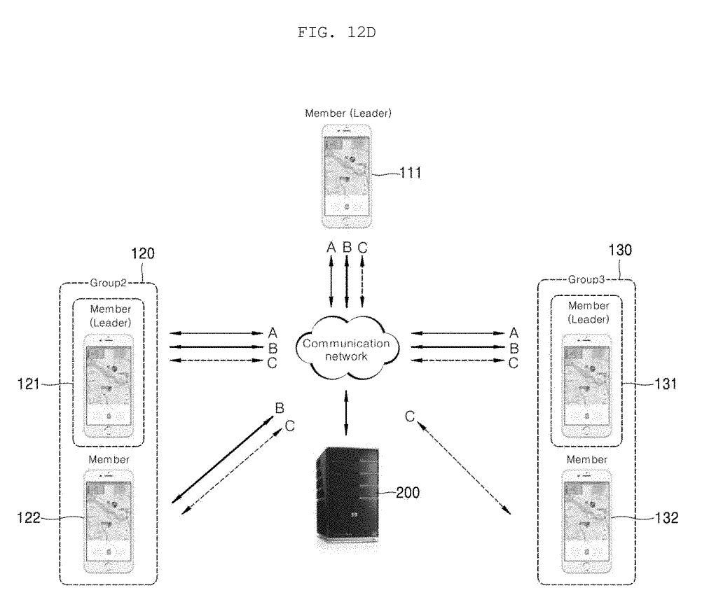

Embodiments of grouping in various ways will be described with reference to FIGS. 12A to 12D. FIGS. 12A to 12D are views illustrating how a method and system of providing a location sharing event for member management according to an exemplary embodiment of the present invention can be variously implemented in a case where a plurality of terminals participate in an event.

First, arrows A, B, and C shown in FIGS. 12A to 12D indicate transmission/reception of voice data, location information, and personal information. As shown in FIG. 12A, a planner terminal 101 and member terminals 102a and 102b may share voice data, location information, and personal information with each other while transmitting and receiving data to and from the server 200. That is, this shows an exemplary embodiment where each of them are set as leader terminals.

FIG. 12B shows a case where two groups are set so that the first group 110 includes a first group leader terminal 111 and first group member terminals 112a and 112b, and the second group 120 includes a second group leader terminal 121 and a second group member terminal 122. Here, each of the first group leader terminal 111 and the second group leader terminal 121 can transmit and receive voice data, location information, and personal information to and from the server 200, but the remaining member terminals 112a, 112b, and 122 cannot transmit/receive voice data to/from the server 200. That is, the voice data, location information, and personal information or each can be set to be selectively transmitted and received to/from the server depending on whether the participant terminal 100 is a leader terminal or not.

FIG. 12C shows a case where two groups are set so that the first group 110 includes a first group leader terminal 111 and first group member terminals 112a and 112b, and the second group 120 includes a second group leader terminal 121 and a second group member terminal 122. Here, each of the first group leader terminal 111 and the second group leader terminal 121 can transmit and receive voice data, location information, and personal information to and from the server 200, but the remaining member terminals 112a, 112b and 122 cannot transmit and receive voice data and location information to and from the server 200.

FIG. 12D shows a case where three groups are set and a first group leader terminal 111 is included in the first group, a second group leader terminal 121 and a second group member terminal 122 are included in a second group 120, and a third group leader terminal 131 and a third group member terminal 132 are included in the third group 130. Here, each of the first group leader terminal 111, the second group leader terminal 121, and the third group leader terminal 131 can transmit and receive voice data, location information, and personal information to/from the server 200. However, the remaining member terminals 122 and 132 cannot transmit/receive a part of the voice data and the location information to/from the server 200.

The grouping function as described above makes it possible to easily arrange a plurality of participant terminals 100 for each group according to the purpose of an event and to selectively transmit voice data, location information and personal information to and from the server 200 so that it is possible to reduce the amount of data transmitted and received at the same time.

While the present invention has been particularly shown and described with reference to exemplary embodiments thereof, it is evident that many alternatives, modifications and variations will be apparent to those skilled in the art. It will be understood by those skilled in the art that various changes in form and details may be made therein without departing from the spirit and scope of the invention as defined by the appended claims.

In addition, since the present invention can be embodied in various forms, and should not be construed as being limited to the embodiments set forth herein. Rather, these embodiments are provided so that this disclosure will be thorough and complete and will fully convey the concept of the invention to those skilled in the art, and the present disclosure will only be defined by the appended claims.

What is claimed is:

1. A method of providing a location sharing event for member management, comprising:
(a) creating an event through a planner terminal;
(b) inputting personal information in the planner terminal;
(c) sharing an invitation link from the planner terminal to a member terminal;
(d) the member terminal participating in the event as the member terminal receives the invitation link and inputs personal information of the member terminal;
(e) editing a grouping state of the planner terminal and the member terminal to set at least two leader terminals before the event starts, and displaying a real time shared screen on each of the screens of the planner terminal and the member terminal by starting the event;
(f) determining whether a PTT (push to talk) function is in an activated state; and
(g) in the case where the PTT function is activated, transmitting a voice data through a communications network from any one of the at least two leader terminals, and transmitting the voice data from a server to another one of the at least two terminals,
wherein location information of the at least two leader terminals are displayed simultaneously on the real time shared screen.

2. The method of claim 1, wherein step (a) comprises the steps of,
(a1) inputting a name of the event through the planner terminal; and
(a2) inputting a start date and end date of the event through the planner terminal.

3. The method of claim 1, wherein while the location Information of the at least two leader terminals is displayed simultaneously on the real time shared screen, they are displayed differently based on their connection state with a server.

4. A system of providing a location sharing event for member management comprising:
a planner terminal;
at least one member terminal invited to an event created by the planner terminal; and
a server communicable with the planner terminal and the member terminal through a communications network,
wherein the server includes a connection management module, service management module, and a voice authority management module, and
the member terminal gets to participate in the event when the member terminal receives the invitation link and inputs personal information of the member terminal, and by the editing of a grouping state of the planner terminal and the member terminal, at least two leader terminals are set, and
location information of each of the at least two leader terminals are configured by the server and displayed simultaneously, and
the voice authority management module determines whether a PTT (push to talk) function is in an activated state, and if the PTT function is activated, a voice data is transmitted through a communications network from any one of the at least two leader terminals, and the voice data is transmitted from the server to another one of the at least two leader terminals.

5. The system of claim 4, wherein the service management module manages a service list including at least one of a service event list, a login, map location information, a voice relay, an event information provision, and a participant information provision service.
